(19) United States
(12) Patent Application Publication
(10) Pub. No.: US 2022/0300784 A1
(43) Pub. Date: Sep. 22, 2022

(54) COMPUTER-READABLE RECORDING MEDIUM HAVING STORED THEREIN MACHINE-LEARNING PROGRAM, METHOD FOR MACHINE LEARNING, AND CALCULATING MACHINE

(71) Applicant: FUJITSU LIMITED, Kawasaki-shi (JP)

(72) Inventor: Yukihito Kawabe, Kawasaki (JP)

(73) Assignee: FUJITSU LIMITED, Kawasaki-shi (JP)

(21) Appl. No.: 17/541,320

(22) Filed: Dec. 3, 2021

(30) Foreign Application Priority Data
Mar. 19, 2021 (JP) 2021-045970

(51) Int. Cl. G06N 3/04

(52) U.S. Cl. CPC G06N 3/04

(57) ABSTRACT

A non-transitory computer-readable recording medium having stored therein a machine learning program executable by one or more computers, the machine learning program includes: in a quantizing process that reduces a bit width to be used for data expression of a parameter included in a machine-learned model in a neural network including a convolution layer, scaling, based on a result of scaling input data in the convolution layer for each input channel, weight data in the convolution layer for the channel; and quantizing the scaled weight data for each output channel of multi-dimensional output data of the convolution layer.

### CROSS-REFERENCE TO RELATED APPLICATION

This application is based upon and claims the benefit of priority of the prior Japanese Patent application No. 2021-045970, filed on Mar. 19, 2021, the entire contents of which are incorporated herein by reference.

### FIELD

The embodiment discussed herein is directed to a computer-readable recording medium having stored therein a machine-learning program, a method for machine learning, and a calculating machine.

### BACKGROUND

As a Neural Network (NN) for implementing an Artificial Intelligence (AI) task such as an image-recognition task or an object detection task, a NN including a convolution layer has been known.

A Deep NN (DNN), which is an example of a NN including a convolution layer, is an NN that has a basic configuration in which pairs of a convolution layer and an activation function (Activation) layer are connected in series over multiple stages, and is exemplified by an NN in which dozens of convolution layers are connected in series.

Note that examples of a NN including the convolution layers, may be various NNs having graphs provided with additional structures. Examples of the additional structure include a structure that interposes various layers, such as a batch normalization layer and a pooling layer between pairs of the convolution layer and the activation function layer, or a structure in which a process is branched at the middle the series structure and then merged after several stages.
[Patent document 1] Japanese Laid-Open Patent Publication No. 2019-32833
[Patent document 2] U.S. Patent Publication No. 2019/0042935

In order to improve the inference accuracy, e.g., the recognition accuracy, of an inferring process that uses the machine-learned model generated by the machine learning of a DNN, a large-scale NN in which one or the both of the size and the number of stages of layers of the NN are increased may be used. In machine learning process of such a large-scale NN, a large amount of calculation resources is used, and power consumption for using the large amount of calculation resources also increases.

Examples of a calculating machine (computer) serving as an environment for executing an inferring process is an apparatus having limited resources such as calculating capacity, a memory capacity, and a power supply, and specifically is a mobile phone, a drone, an Internet of Things (IoT) device, and the like. However, it is difficult to execute an inferring process with a large-scale NN used for machine learning by using a device in which such computational resources have constraints.

Quantization is known as one of the schemes to reduce the data-size and the calculating volume in an inferring process by reducing the size of the DNN while suppressing degrading of the recognition accuracy obtained through the machine learning.

The weight data provided to convolution layers in a DNN and the data propagating through a DNN may be expressed by using, for example, a 32-bit floating point (sometimes referred to as “FP32”) type greater than 8 or 16 bits in order to enhance inference accuracy.

In the quantization, by converting the value of one or both of the weight data obtained as a result of machine learning and the data flowing through the NN into a data type having a bit width smaller than 32 bits at the time of the machine learning, it is possible to reduce the data volume and reduce the calculation load in a NN.

However, the above quantizing scheme still has a room for improvement.

### SUMMARY

According to an aspect of the embodiments, a non-transitory computer-readable recording medium having stored therein a machine learning program executable by one or more computers, the machine learning program includes: in a quantizing process that reduces a bit width to be used for data expression of a parameter included in a machine-learned model in a neural network including a convolution layer, scaling, based on a result of scaling input data in the convolution layer for each input channel, weight data in the convolution layer for the channel; and quantizing the scaled weight data for each output channel of multi-dimensional output data of the convolution layer.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a DNN;

FIG. 2 is a diagram illustrating an example of data expression in a DNN;

FIG. 3 is a diagram illustrating an example of a quantizing scheme;

FIG. 4 is a diagram illustrating an example of operation of a machine-learning system;

FIG. 5 is a diagram illustrating an example of operation of an inferring process;

FIG. 6 is a diagram illustrating an example of data structure of input and output data into and from a convolution layer of a DNN;

FIG. 7 is a diagram illustrating an example of a DNN that executes per-tensor quantization;

FIG. 8 is a diagram illustrating an example of a DNN that executes per-tensor quantization and per-channel quantization;

FIG. 9 is a diagram illustrating an example of a DNN that executes per-channel quantization;

FIG. 10 is a block diagram illustrating an example of a functional configuration of a system according to one embodiment;

FIG. 11 is a diagram illustrating an example of an obtaining process of a minimum value and a maximum value of each channel by an optimization processing unit;

FIG. 12 is a diagram illustrating an example of operation of an inferring process;

FIG. 13 is a diagram illustrating an example of comparing results of improving inference accuracy when the target of per-channel quantization is “a weight only” and “an input and a weight”;

FIG. 14 is a flow diagram illustrating an example of operation of an optimizing process in a machine learning process according to the one embodiment;

FIG. 15 is a flow diagram illustrating an example of operation of a modification to the one embodiment; and

FIG. 16 is a block diagram illustrating an example of the hardware (HW) configuration of a computer.

### DESCRIPTION OF EMBODIMENT(S)

Hereinafter, an embodiment of the present invention will now be described with reference to the accompanying drawings. However, the embodiment described below is merely illustrative and there is no intention to exclude the application of various modifications and techniques that are not explicitly described below. For example, the present embodiment can be variously modified and implemented without departing from the scope thereof. In the drawings to be used in the following description, like reference numbers denote the same or similar parts, unless otherwise specified.

[1] One Embodiment:

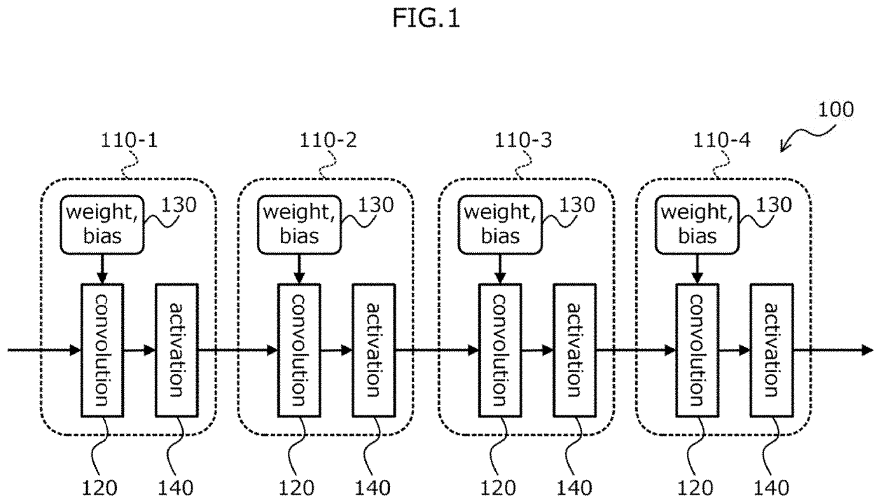

FIG. 1 is a diagram illustrating an example of a DNN 100. The DNN 100 is an example of a NN including convolution layers according to one embodiment. As illustrated in FIG. 1, the DNN 100 includes multiple stages (four stages in the example of FIG. 1) of networks 110-1 to 110-4 (hereinafter, simply referred to as “network 110” when the networks are not distinguished from each other). Each network 110 includes a pair of a convolution layer 120 and an activation function layer 140. The convolution layer 120 is provided with weight and bias data 130 (hereinafter collectively referred to as “weight data 130”). In the one embodiment, the description will now be made on the basis of the configuration of the DNN 100 illustrated in FIG. 1. The following description assumes that a normalization linear unit (Rectified Linear Unit (Relu)) layer is used as the activation function layer 140.

(An Example of a Quantizing Scheme)

First, description will now be made in relation to a quantizing scheme for reducing the size of the DNN 100. In the quantizing scheme, the data volume handled by the DNN 100 itself can be reduced by reducing a bit width.

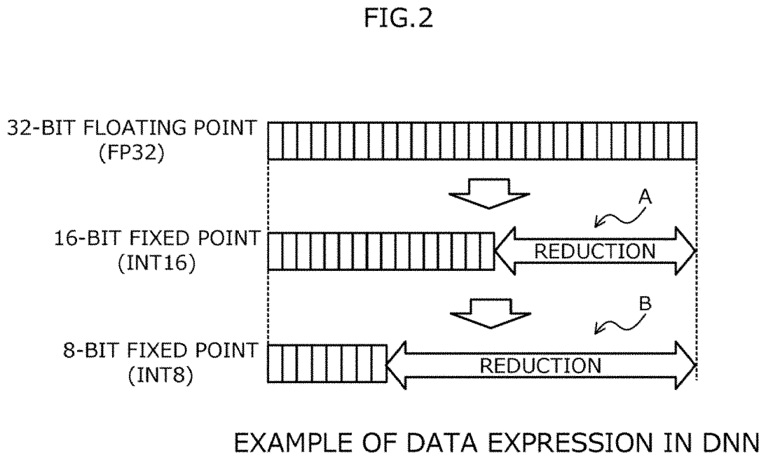

FIG. 2 is a diagram illustrating an example of data expression in the DNN 100. As illustrated in FIG. 2, according to the quantizing scheme, quantization on the data expression in the DNN 100 from a 32-bit floating point (FP32) to a 16-bit fixed point (hereinafter referred to as “INT16”) can reduce the data volume indicated by the arrow A. Furthermore, quantization on the data expression from the INT16 to an 8-bit fixed point (hereinafter referred to as “INT8”) can reduce the data volume indicated by arrow B from the data volume of the FP32.

As described above, the quantizing scheme can reduce the data volume of the weight data 130 and data propagating through the networks 110 of the DNN 100, so that the size of the DNN 100 can be reduced. In addition, by performing a packed-SIMD (Single Instruction, Multiple Data) operation or the like, multiple (e.g., four) INT8 instructions are collectively operated as one instruction, and consequently, the number of instructions can be reduced and the machine-learning time using the DNN 100 can be shortened.

When the FP32 is converted to the INT8 by the quantizing scheme, the FP32 has a larger numerical expression range than that of the INT8, and therefore, simply converting the value of the FP32 into the value of the nearest INT8 causes a drop of information, which may degrade the inference accuracy based on the result of machine-learning. A drop of information may occur, for example, in a rounding process that rounds digits less than “1” and a saturating process that saturates numbers larger than “127” to “127”.

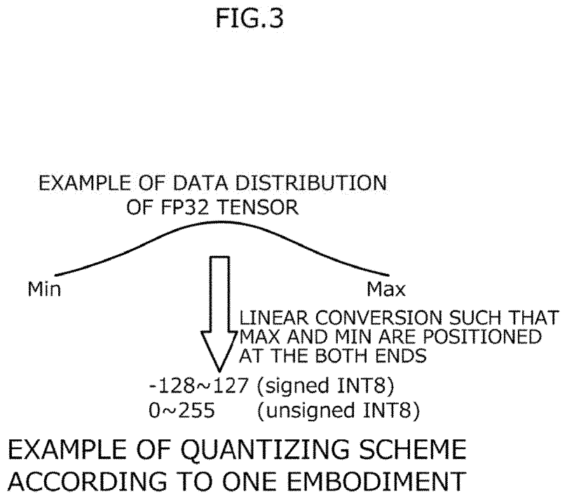

Therefore, the one embodiment uses a quantizing scheme illustrated in FIG. 3. FIG. 3 is a diagram illustrating an example of the quantizing scheme. In FIG. 3, a “tensor” indicates multi-dimensional data of input and output of respective layers processed at a time in units of batch sizes in the DNN 100.

The quantizing scheme illustrated in FIG. 3 converts a value r of the FP32 into a value q of the INT8 by a linear conversion and a rounding process being based on the following Expression (1) and using two quantization parameters of a constants S (scale) and Z (Zero point).

q=round(r/S)+Z (1)

In the above Expression (1), “round( )” represents a rounding process. The constant S may be a constant (e.g., a real number) to adjust the scale of the real number r (FP32) before the quantization and the integer q (INT8) after the quantization. The constant Z may be an offset (bias) to adjust the real number q (INT8) such that the real number r (FP32) is represented by 0 (zero).

In the example of FIG. 3, according to the above Expression (1), the values of the FP32 in the data distribution of the tensor of the FP32 is linearly converted such that the minimum value (Min) and the maximum value (Max) are set to be the both end values. For example, when the data set of FP32 is quantized into 8-bit data, the constants S and Z for quantizing the entire data set without waste are expressed by the following Expression (2) and the following Expression (3-1) or (3-2) using the minimum value (Min) and the maximum value (Max) of the data set. The following Expression (3-1) is one when the integer q is an unsigned integer (unsigned INT), and the following Expression (3-2) is one when the integer q is a signed integer (signed INT).

S=(Max−Min)/255 (2)

Z=round(−(Max+Min)/2S) (3-1)

Z=round(−Min/S) (3-2)

The quantizing scheme may be adopt, for example, a scheme described in Reference “Quantization and Training of Neural Networks for Efficient Integer-Arithmetic-Only Inference” (Internet site: arxiv.org/abs/1712.05877).

In one embodiment, quantization from the FP32 to the INT8 is performed using the scheme described in the above reference. Hereinafter, the scheme described in the above reference is referred to as a QINT (Quantized Integer) scheme, and an integer quantized by the scheme described in the above reference is referred to as QINTx (x is an integer indicating a bit width such as “8”, “16”, or “32”). The constants S and Z can be calculated from the minimum value and the maximum value in a tensor. For this reason, in the one embodiment, the value of the QINT8 is assumed to include “an INT8 tensor, the minimum value, and the maximum value”.

(Example of Operation of Machine Learning Process and Inferring Process)

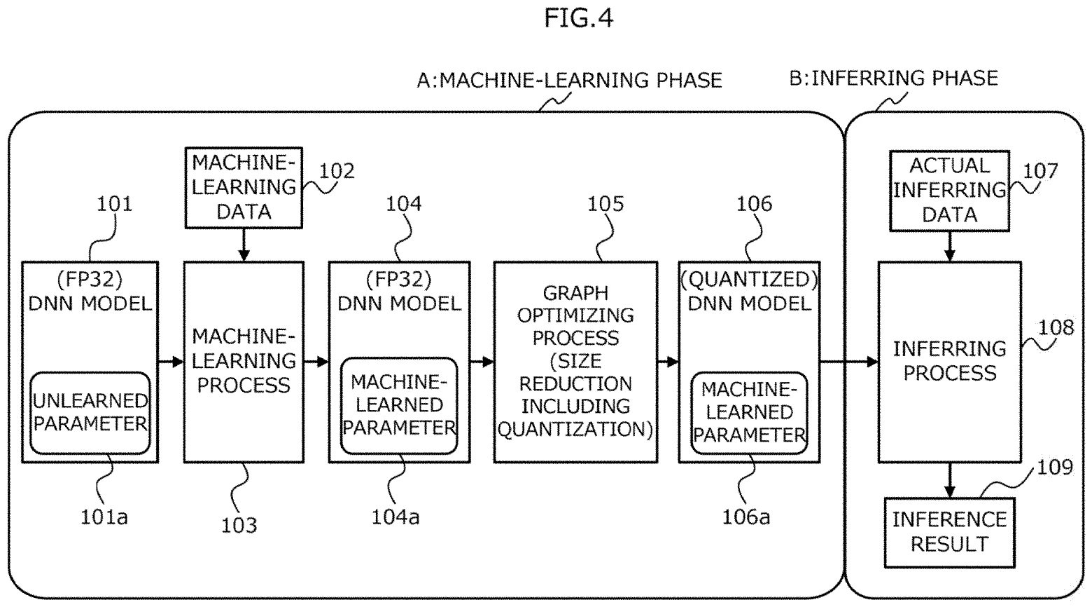

FIG. 4 is a diagram illustrating an example of an operation of a machine-learning system. As illustrated in FIG. 4, in a machine-learning phase denoted by symbol A, a provider that provides a machine-learned model generates a machine-learned DNN model 106 from an unlearned DNN model 101. In the inferring phase indicated by the symbol B, the user provided with the DNN model 106 performs an inferring process 108 using the actual inferring data 107 by the DNN model 106, and obtains the inference result 109. The actual inferring data 107 may be, for example, an image, and the inference result 109 may be, for example, result of object detection from the image.

The machine-learning phase may be performed once for each DNN model 106, for example, using a sophisticated calculating machine such as a GPU-mounted Personal Computer (PC) or a server. The inferring phase may be executed multiple times by changing the actual inferring data 107 using a calculating machine such as an edge device.

In the machine-learning phase, for example, the calculating machine executes a machine-learning process 103 using the machine-learning data 102 on an unlearned parameters 101a of a DNN model 101 expressed in the FP32, and obtains a machine-learned parameters 104a as the result of the machine learning.

In the machine-learning phase of the one embodiment, the calculating machine performs a graph optimizing process 105 on the machine-learned parameters 104a of the DNN model 104 expressed in the FP32 to obtain the machine-learned parameters 106a of the DNN model 106. The graph optimizing process 105 is a size reducing process including a quantizing process to convert the FP32 representing the DNN model 104 into the QINT8 or the like, and a size-reduced DNN model 106 expressed in the QINT8 or the like is generated by the graph optimizing process 105.

The quantizing process is a process to reduce the bit width used for data expression of parameters included in the machine-learned model of a neural network including one or more convolution layers. Details of the quantizing process will be described below in the description of the one embodiment.

(Example of Graph Optimizing Process)

The graph optimizing process 105 illustrated in FIG. 4 will now be briefly described below. In the graph optimizing process 105, the following processes (I) to (IV) may be performed.

(I) Preprocess:

The calculating machine performs, for example, preprocess exemplified in (I-1) and (I-2) below.

(I-1) In the machine learning process 103 illustrated in FIG. 4, the machine-learned parameters 104a (parameters such as machine-learned weights) are stored in a variable layer of the DNN model 104. The calculating machine converts the variable layer to a constant layer for processing reduction when handling machine-learned parameters 104a and the graph optimizing process 105.

(I-2) the Calculating Machine Optimizes the Networks.

For example, the calculating machine may delete a layer (not used in the inferring phase) used in the machine learning, such as Dropout, from the constant layers obtained by the conversion.

The batch normalization layer is a layer that performs a simple linear conversion in the inferring process, and therefore can be merged and fallen back with the process a former and/or subsequent layers in many cases. Similarly, multiple layers, such as a combination of a convolution layer and a normalization linear unit (Relu) layer, a combination of a convolution layer, a batch normalization layer, and a normalization linear unit layer, a combination of a convolution layer, a batch normalization layer, an add layer, and a normalization linear unit layer, may be merged as a single layer to reduce memory accesses. In this way, the calculating machine reduce the size of the graph before undergoing the quantization by merging or falling back layers, utilizing a weight being a constant, and (uniquely) optimizing to fit the inferring process.

(II) Determine Layer to be Quantized:

The calculating machine determines the layer (e.g., network 110 illustrated in FIG. 1) to be quantized in the DNN model 104.

(III) Calibrating Process:

In order to convert a value of an FP32 or a value of an INT32 as a result of convolution or the like into a QINT8, a generating and propagating process of the minimum value (min) and the maximum value (max) is performed. In the generating and propagating process, a process called ReduceMin and ReduceMax that obtains the minimum value and the maximum value from a tensor is a tensor calculation performed for each batch process, and therefore the process takes a long time. Since the other operation in the generating and propagating process is a scalar operation and therefore the result of the scalar operation can be reused if once the calculation is carried out, the calculation processing time is smaller than the calculation processing time of the ReduceMin and the ReduceMax.

Therefore, in the quantization for the inferring process, the calculating machine executes, as the calibrating process, an inferring process using calibration data serving as a reduced version of the machine-learning data 102 beforehand, obtains the minimum value and the maximum value of the data flowing through each layer, and embeds the obtained values as constant values in the network. The calibration data may be, for example, partial data obtained by extracting a part of the machine-learning data 102 so as to reduce the bias, and may be, for example, an overall part or a part of the input data of the machine-learning data 102 including the input data and the correct answer value (supervisor data).

(IV) Graph Converting Process:

The calculating machine converts a layer to be processed by the QINT8 in the network into a QINT8 layers. At this time, the calculating machine embeds the maximum value and the minimum value of the QINT8, which are determined in the calibrating process, as constant values, into the network. The calculating machine also performs quantization on a weight parameter to the QINT8.

In the inferring phase, the calculating machine of the user, for example, performs quantization by using the minimum value and the maximum value that the calculating machine of the provider embeds in the network through the above processes (I) to (IV), in place of the minimum value and the maximum value obtained by a tensor flowing in the network.

Since the actual inferring data 107 and the calibration data are different from each other, data outside the range of the minimum value (or the maximum value) may be input in the inferring phase (actual practice), but in such a case, the calculating machine of the user may convert the data outside the range into the minimum value and the maximum value.

(Description of Inferring Process)

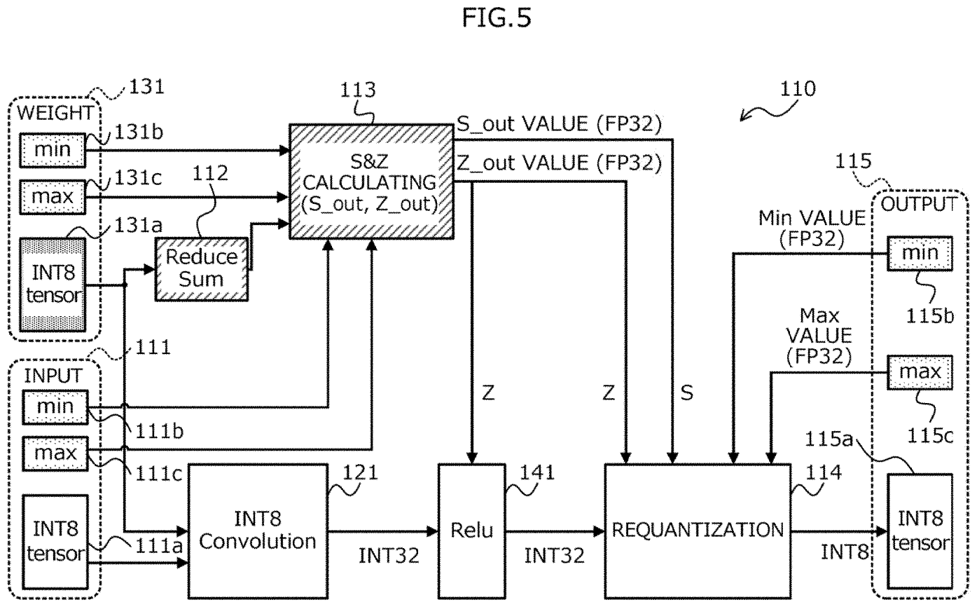

FIG. 5 is a diagram illustrating an example of operation of an inferring process. FIG. 5 illustrates the flow of a process for one stage of a combination of the convolution layer and the normalization linear unit layer (see network 110 of FIG. 1) in cases where the activation function layer of DNN 100 illustrated in FIG. 1 is a normalization linear unit (Relu) layer.

As illustrated in FIG. 5, QINT quantized data serving as the input and output of the layer is stored in the network 110 in combination of three piece of data, i.e., “the INT8 tensor, the minimum value, and the maximum value”. In the embodiment of FIG. 5, QINT quantized data is input data 111, weight data 131, and output data 115. The input data 111 includes an INT8 tensor 111a, a minimum value 111b, and a maximum value 111c; the weight data 131 includes an INT8 tensor 131a, a minimum value 131b, and a maximum value 131c; and the output data 115 includes an INT8 tensor 115a, a minimum value 115b, and a maximum value 115c.

Here, the INT8 tensor 131a indicated by dark hatching in FIG. 5 is a constant value obtained by quantizing the weight of the result of learning in the machine learning process 103. Each of the minimum values 111b, 131b, and 115b, and the maximum values 111c, 131c, and 115c indicated by the thin hatching is a constant value in which the result of the calibrating process is embedded.

A ReduceSum 112 and an S&Z calculating 113 indicated by shading in FIG. 5 each perform an operation for output quantization. Since all inputs into the ReduceSum 112 and the S&Z calculating 113 are constants, the operation therein may be executed once in the inferring process.

The ReduceSum 112 adds the elements of all dimensions of the INT8 tensor 131a and outputs one tensor.

The S&Z calculating 113 calculates an S value (S_out) and a Z value (Z_out) of the output data 115 by performing a scalar operation according to the following Expressions (4) and (5).

S_out=S_in·S_w (4)

Z_out=Z_in·Σ₁ₘₙw(int8)[1][m][n] (5)

In the above Expressions (4) and (5), the terms S_in and Z_in are the S value and the Z value of the input data 111, respectively, and the term S_w is the S value of the weight data 131. The values S_in, Z_in, and S_w may be calculated on the basis of the minimum values 111b and 131b and the maximum values 111c and 131c according to the Expression (2) and the Expression (3-1) or (3-2). The term “w(int8)” represents an INT8 tensor 131a. The symbols “1, m, and n” are indexes of the “H-, W-, and C-” dimensions of a filter described below in the weight data 131, respectively.

The calculation of “Σ₁ₘₙw(int8) [1][m][n]” in the above Expression (5) adds the elements of all the dimensions of an INT8 tensor 131a, and may be the result of the process by the ReduceSum 112. For convenience of the calculation, the S&Z calculating 113 performs quantizing process with “Z_w=0” for the Z value (Z_w) of the weight. Thus, the S&Z calculating 113 can calculate the Z_out based on the INT8 tensor 131a of the weight data 131 without using the INT8 tensor 111a of the input data 111.

The convolution 121 performs a convolution process on the basis of the INT8 tensors 111a and 131a, and outputs INT32 value of the accumulation registers. For example, the convolution 121 performs a convolution process according to the following Expression (6).

out(FP32)[i][j][k]=S_in·S_w{Conv(i,j,k)(in(int8),w(int8))Z_in·−Σ1mnw(int8)[1][m][n]} (6)

In the above equation (6), the symbols “i, j, and k” are indexes of the “H-, W-, and C-” dimensions, respectively, and the symbols “1, m, n” are indexes of the “H-, W-, C-” dimensions of the filters. The term “Conv(i,j,k)” indicates a convolution operation in which a weight is applied to the coordinate [i,j,k] of the input data 111.

The Relu 141 performs a threshold process on the basis of the output from the convolution 121 and the Z_out value from the S&Z calculating 113 and then outputs an INT32 value.

The requantization 114 performs requantization based on the output from the Relu 141, the S_out value and the Z_out value from the S&Z calculating 113, and the minimum value 115b and the maximum value 115c, and then outputs an INT8 tensor 115a (out(INT8)) of the INT8 value.

(Example of Data Structure of Input/Output Data of Convolution Layer 120)

Next, description will now be made in relation to the input/output data of the convolution layer 120 (see FIG. 1) on the assumption that a convolution-based NN processes image data. Hereinafter, the input/output data of the convolution layer 120 is, for example, four-dimensional data of N, C, H, and W. The dimension N represents a batch size, in other words, the number of images processed at one time; the dimension C represents the number of channels; the dimension H represents the height of an image; and the dimension W represents the width of the image.

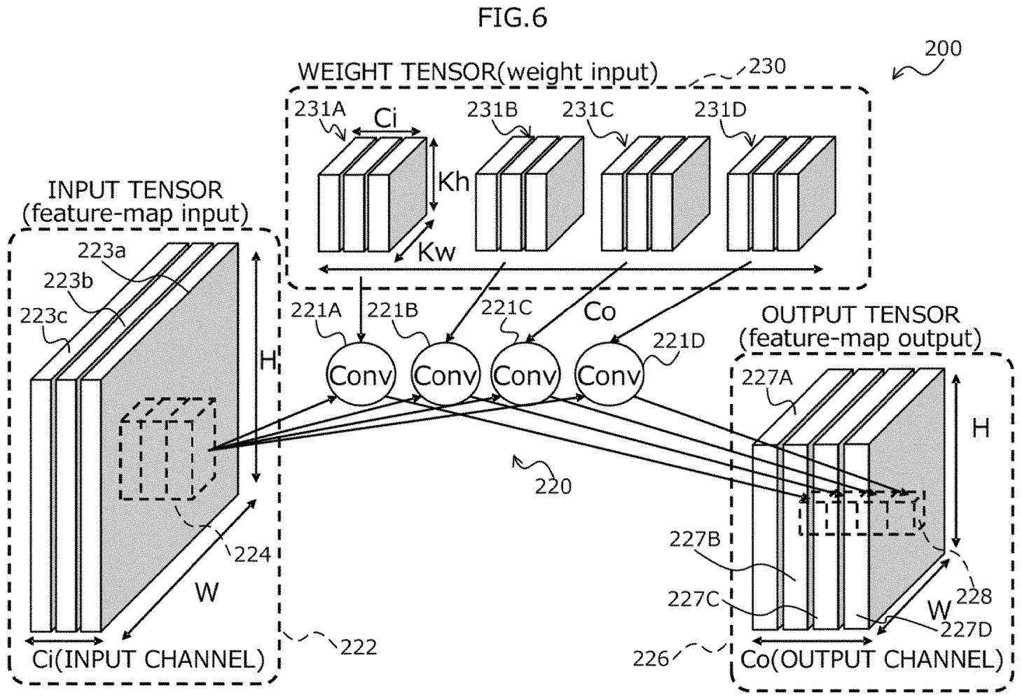

FIG. 6 is a diagram illustrating an example of data structure of input/output data into and from the convolution layer 220 in the DNN 200. As illustrated in FIG. 6, the convolution layer 220 is an example of the convolution layer 120 illustrated in FIG. 1, and may include multiple convolution processing units 221A to 221D that each perform a convolution process for one of the filters 231. An input tensor 222 is input into the convolution processing units 221A to 221D, output tensors 226 are output from the convolution processing units 221A to 221D. Hereinafter, when an element is not distinguished, the suffixes a to c and A to D included in the respective reference numbers of the elements are omitted. For example, when the convolution processing units 221A to 221D are not distinguished from one another, the convolution processing units are simply referred to as “convolution processing units 221”.

The input tensor 222 is an example of input data of the convolution layer 220 and may include, such as a Feature Map, based on at least part of the image data. The example of FIG. 6 assumes that the input tensor 222 is a three-dimensional tensor of W×H×Ci in the form of Ci (the number of input channels) feature maps each having a size of a width W and a height H and being arranged in the direction of the channels (input channels) 223a to 223c. The value of the number Ci of channels of the channel 223 may be determined according to the number of filters of the weight applied to the convolution layer 220 immediately before (upstream of) a target convolution layer 220. That is, the input tensor 222 is an output tensor 226 from the upstream convolution layer 220.

The weight tensor 230 is an example of weight data (e.g., weight data 130 illustrated in FIG. 1) and has multiple filters 231A to 231D including grid-shaped numerical data. The weight tensor 230 may include channels corresponding one to each of multiple input channels 223 of the input tensor 222. For example, the filter 231 of the weight tensor 230 may have multiple channels the same in number as the number Ci of channels of an input tensor 222. The filter 231 may be referred to as a “kernel”.

The convolution processing unit 221 converts the channel of the filter 231 corresponding to the channel 223 and the numerical data of a window 224 having the same size as the filter 231 in the channel 223 into one numerical data 228 by calculating the sum of the products of the respective elements. For example, the convolution processing unit 221 converts the input tensor 222 to the output tensor 226 by performing a converting process on windows 224 shifted little by little and outputting multiple numerical data 228 each in a grid form.

The output tensor 226 is an example of multi-dimensional output data of the convolution layer 220 and may include information based on at least part of the image data, for example, a Feature Map. The example of FIG. 6 assumes that the output tensor 226 is a three-dimensional tensor of W×H×Co in the form of Co (number of output channels) feature maps each having a width W and a height H and being arranged in the direction of the channels (input channels) 227A to 227D. The value of the number Co of channels of the channels 227 may be determined according to the number of filters of weights applied to a target convolution processing unit 221.

FIG. 6 assumes a case where N is “1”. When N is “n” (where “n” is an integer equal to or larger than “2”), the number of each of input tensors 222 and output tensors 226 is “n”.

In the example of FIG. 6, focusing on a particular convolution processing unit 221, the shape (shape) of the input tensor 222 is denoted as [N:Ci:Hi:Wi], the size of the filter 231 of the weight tensor 230 is represented by the height Kh×width Kw, and the number of filters is represented by Co. For example, when the filter 231k (k is information specifying any one of the filters 231A to 231D) is applied to the position (x, y) of the input data I, the inner product calculation for one filter 231 is calculated as illustrated in the following Expression (7).

Output=Σ_{c=0}^{Ci-1}Σᵢ₌₀^{Kh-1}Σⱼ₌₀^{Kw-1}I_{x+i,y+j,c}k_{i,j,c} (7)

Here, the symbol c is a variable indicating the channel 223 and may be an integer ranging from 0 to (Ci−1). The subscripts i and j of E are variables indicating the position (i, j) of the filter 231. Specifically, i may be an integer in the range of 0 to (Kh−1), and j may be an integer in the range of 0 to (Kw−1).

For example, since the calculation based on the above Expression (7) is performed by the Co filters 231 for N pieces of image data at one filter application position, N×Co pieces of data 228 are output for one coordinate. It is assumed that the filter 231 is applied Ho times in the height direction and Wo times in the width direction. The shape of the weight tensor 230 is assume to be expressed by [Co:Ci:Kh:Kw], the shape of the output tensor 226 of the convolution processing unit 221 is [N:Co:Ho:Wo]. That is, the number of channels Co of the output tensor 226 becomes the number of filters Co of the weight tensor 230.

Focusing on the above Expression (7), it is understood that the inner product calculation for one filter 231 is a product sum calculation across the input tensors 222 (the entire number of channels Ci).

(Description of Quantizing Process)

Incidentally, the quantizing process by the QINT scheme includes schemes of per-tensor quantization and per-axis quantization.

The per-tensor quantization is a quantizing process that quantizes an entire input tensor using one S value and one Z value.

The per-axis quantization is a quantizing process executed in units of individual partial tensor sliced in one focused dimension among multiple dimensions of an input tensor. In the per-axis quantization, the values S and Z are individually present for each element of the dimension used for the slicing, and consequently, each of S and Z has a value as a vector of one dimension.

The scheme of quantizing a partial tensor sliced in the channel direction, one of the per-axis quantization, is referred to as per-channel quantization.

In the QINT scheme, S and Z are calculated by using the minimum value (Min) and the maximum value (Max) of the entire distribution of the data to be quantized such that the overall range of the distribution is quantized without waste as the above Expression (2) and the above Expression (3-1) or (3-2) above.

For this reason, for example, in cases where the widths of the data distributions of the respective channels to be input are different or the position of the distribution is shifted even if the widths of the data distributions are substantially the same, the per-channel quantization can express data in a finer granularity than the per-tensor quantization.

Due to such properties, for example, an inferring process can achieve a high recognition accuracy by per-channel quantization rather than using a NN subjected to per-tensor quantization.

Since the convolution process has two inputs of a data input and a weight input, the per-channel quantization is applied to the following three types of targets (i) to (iii).

(i) data input: per-tensor quantization, and weight input: per-channel quantization

(ii) data input: per-channel quantization, and weight input: per-tensor quantization

(iii) data input: per-channel quantization, weight input; and per-channel quantization

The granularity of the quantizing process is finer in the case (iii) than in the cases (i) and (ii), and in the case (iii), in the requantization after Relu, the QINT 32 of the input and the QINT8 of the output becomes per-channel quantized data, so that the loss of information is small. Accordingly, it can be said that the recognition accuracy of the case (iii) is higher than those of the above cases (i) and (ii).

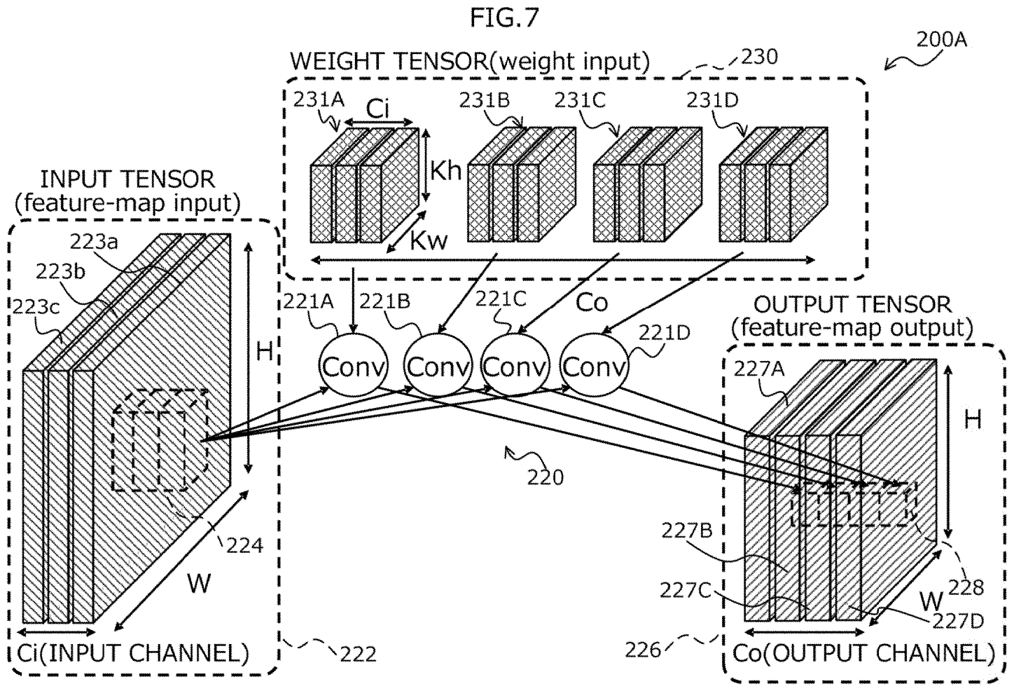

FIG. 7 is a diagram illustrating a DNN 200A that performs the per-tensor quantization. Hereinafter, in the descriptions of FIGS. 7 to 9, elements applied with the same S and Z values are hatched or shaded the same among the channels 223a to 223c, the filters 231A to 231D, and the channel 227A to 227D.

In the example of FIG. 7, the per-tensor quantization is performed on each of the input tensor 222, the weight tensor 230, and the output tensor 226. This means that in each of the input tensor 222, the weight tensor 230, and the output tensor 226, the entire tensor is quantized with one S value and one Z value. In the convolution layer 220, the converting process can be executed by using INT-type data. Performing the per-tensor quantization on all tensors makes it possible to calculate the values of S and Z for output with a small calculation volume.

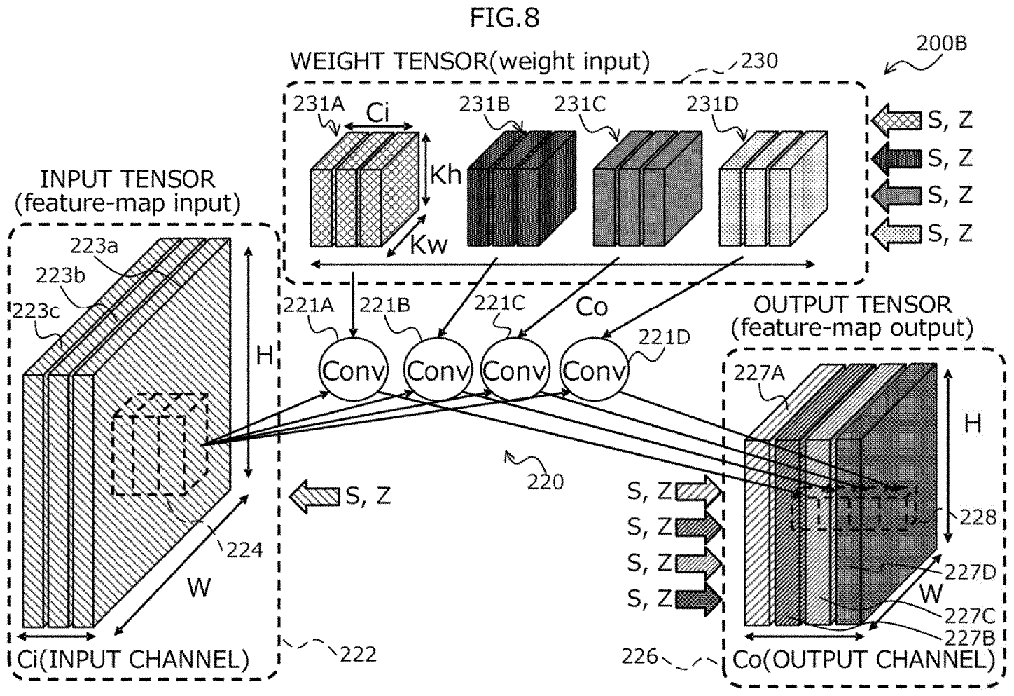

FIG. 8 is a diagram illustrating a DNN 200B that performs the per-tensor quantization and the per-channel quantization, and serves as an example of the above case (i). In the example of FIG. 8, the per-tensor quantization is performed on the input tensor 222, and per-channel quantization is performed on each of the weight tensor 230 and the output tensor 226.

The weight tensor 230 is quantized by a filter 231, which is a unit sliced in terms of the Co. Since the weight input of the individual inner product calculation in the convolution processing unit 221 uses a single filter 231, the convolution process using the inner product calculation of the INT8 can be performed, similarly to the per-tensor quantization.

The calculation for S and Z of the individual channels of the output tensor 226 can also be calculated using S and Z of the corresponding filter 231 of the weight tensor 230 like the per-tensor quantization. As a result, S and Z for output can be calculated with a small calculation volume for each output channel 227.

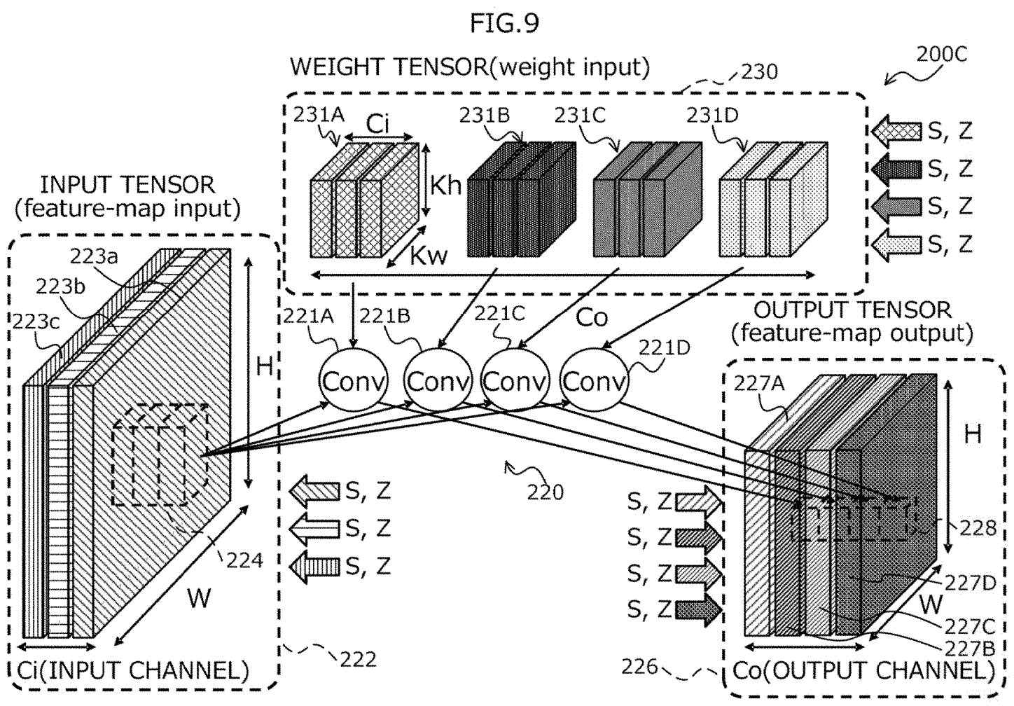

FIG. 9 is a diagram illustrating a DNN 200C that performs the per-channel quantization, and is an example of the above case (iii). In the example of FIG. 9, the per-channel quantization is performed on each of the input tensor 222, the weight tensor 230, and the output tensor 226.

Here, as understood from the above Expression (7) as an example of a calculation expression in the convolution processing unit 221, the inner product calculation in the convolution layer 220 is a product-sum calculation across the input tensor 222 (the entire number of channels Ci).

In the example of FIG. 8, when the per-channel quantization is performed in the direction of the Co (output channel) using the weight tensor 230, since the inner product expression of the above expression (7) quantizes all the product terms with the same S and Z, the entire expression (7) can be calculated in the INT8 operating unit. This means that the values S and Z can be calculated separately from the inner product.

On the other hand, in the method exemplified in FIG. 9 or the scheme corresponding to the above (ii), the S value and the Z value for “I_{x-i, y-j, c}” in the above Expression (7) are different with each c. For this reason, in the convolution layer 220, it is difficult to calculate the inner product by keeping the data of the input tensor 222 the INT8. Therefore, the scheme illustrated in FIG. 9 or the scheme corresponding to the above (ii) is often not considered in the existing AI framework or the like.

Further, in order to achieve the scheme illustrated in FIG. 9, or a scheme corresponding to the above (ii), a process of regaining from the INT8 to the FP32 is performed on the data of the input tensor 222 before being input in the convolution layer 220. However, the conversion from the INT8 to the FP32 is complex calculation and involves increased computational load and processing times. Therefore, as illustrated in FIG. 8, the per-channel quantization is often applied to weight only among the input and the weight (hereinafter, simply referred to as “weight only”).

Therefore, in the one embodiment, description will now be made in relation to a scheme that enables an inner product calculation of the INT8 in the convolution processing unit 221 by applying per-channel quantization to the both an input and a weight while suppressing an increase in the processing load and the processing time in the inferring process. The following description is made with reference to the DNN 200 illustrated in FIG. 6.

[1-1] Example of Functional Configuration of System According to One Embodiment

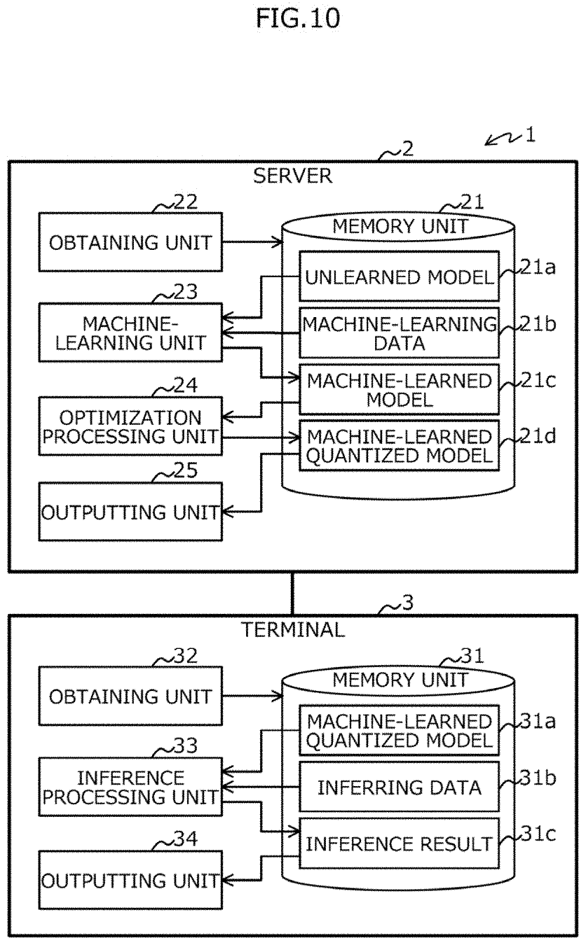

FIG. 10 is a block diagram illustrating an example of the functional configuration of the system 1 according to the embodiment. As illustrated in FIG. 10, the system 1 may illustratively include a server 2 and a terminal 3.

The server 2 is an example of a calculating machine that provides a machine-learned model, and as illustrated in FIG. 10, may illustratively include a memory unit 21, an obtaining unit 22, a machine-learning unit 23, an optimization processing unit 24, and an outputting unit 25. The obtaining unit 22, the machine-learning unit 23, the optimization processing unit 24, and the outputting unit 25 are examples of the control unit (first control unit).

The memory unit 21 is an example of a storing region, and stores various types of data that the server 2 uses. As illustrated in FIG. 10, the memory unit 21 may illustratively be capable of storing the unlearned model 21a, the machine-learning data 21b, machine-learned model 21c, and the machine-learned quantized model 21d.

The obtaining unit 22 obtains an unlearned model 21a and the machine-learning data 21b, and stores the obtained model and data into the memory unit 21. For example, the obtaining unit 22 may generate one or the both of the unlearned model 21a and the machine-learning data 21b by the server 2, or may receive them from a computer outside the server 2 via a network (not illustrated).

The unlearned model 21a may be a model before the machine learning of a NN including unlearned parameters, and may be a NN including a convolution layer, such as a model of the DNN.

The machine-learning data 21b may be, for example, a training data set used for machine learning (training) of the unlearned model 21a. For example, when a NN is machine-learned to achieve a task for image recognition or object detection, the machine-learning data 21b may include multiple pairs of training data such as image data and supervisor data including a correct answer label for the training data.

The machine-learning unit 23 executes a machine learning process that machine-learns the unlearned model 21a on the basis of the machine-learning data 21b in the machine-learning phase. The machine learning process is an example of the machine learning process 103 described with reference to FIG. 4.

For example, the machine-learning unit 23 may generate the machine-learned model 21c by the machine learning process on the unlearned model 21a. The machine-learned model 21c may be obtained by updating the parameters included in the unlearned model 21a, and may be regarded as, for example, a model as a result of a change from the unlearned model 21a to the machine-learned model 21c through the machine learning process. The machine learning process may be implemented by various known techniques.

The machine-learned model 21c may be an NN model including machine-learned parameters, and may be a NN including a convolution layer, such as a model of a DNN.

Each of the unlearned model 21a and the machine-learned model 21c is assumed to be weight data given to the convolution layer in a DNN and data propagating the DNN that are represented by, for example, a FP32 type.

The optimization processing unit 24 generates a machine-learned quantized model 21d by executing a graph optimizing process of the machine-learned model 21c and stores the generated model 21d into the memory unit 21. For example, the machine-learned quantized model 21d may be generated separately from the machine-learned model 21c, or may be data obtained by updating the machine-learned model 21c through an optimizing process.

Here, as described above, the S value and the Z value in the NN for the inferring process are all determined in the phase of the calibrating process in the quantization of the case (III) in the graph optimizing process. In one embodiment, the optimization processing unit 24 performs a graph optimizing process that utilizes that the S value and the Z value are all determined in the phase of the calibrating process.

For example, the optimization processing unit 24 may correct the value of the weight tensor 230 in the graph optimizing process in order to eliminate the difference in S (scale) among the respective channels 223 under a case where the per-channel quantization is executed on the input data.

In the per-channel quantization on the input tensor 222, if S is S_i (i is the channel number) for each channel 223, the value “1” of the channel j corresponds to S_j/S_k times the value “1” of the channel k when considered in terms of the value of the original FP32. Therefore, by multiplying the value of the input channel k of the weight by S_k/S_j, the product term of the inner product of the above Expression (7) comes to be the same scale.

As the above, the optimization processing unit 24 quantizes the FP32 after being applied with correction (multiplication of the ratio of S) for absorbing the difference in S for each input channel of the weight into the QINT8. Then, the optimization processing unit 24 obtains the machine-learned quantized model 21d by embedding the result of the quantization in the graph. Consequently, the actual inferring process eliminates the requirement for correcting an input channel, which makes the terminal 3 possible to calculate an inner product by product-sum calculation closed to the INT8. In other words, since the correction process is performed at the time of the graph conversion, an increase in the calculation volume in the inferring process can be suppressed.

The following description assumes that the optimization processing unit 24 performs the correction of multiplying the channel k except for the reference channel i by (S_k/S_j), but the present invention is not limited to the assumption. For example, the optimization processing unit 24 can achieve the same effect even if the correction of multiplying (1/S_j) for each of all the input channels j of the weight. In order to minimize the variation of the value due to the correction, the ratio of S is multiplied instead of the reciprocal of S. Details of the optimizing process performed by the optimization processing unit 24 will be described below.

The outputting unit 25 reads and outputs the machine-learned quantized model 21d generated (obtained) by the optimization processing unit 24 from the memory unit 21 and, for example, transmits (provides) the read model 21d to the terminal 3.

The terminal 3 is an example of a calculating machine that executes an inferring process using a machine-learned model, and may include, for example, a memory unit 31, an obtaining unit 32, an inference processing unit 33, and an outputting unit 34, as illustrated in FIG. 10. The obtaining unit 32, the inference processing unit 33, and the outputting unit 34 is an example of a control unit (second control unit).

The memory unit 31 is an example of a storing region and stores various types of data that the terminal 3 uses. As illustrated in FIG. 10, the memory unit 31 may illustratively be capable of storing a machine-learned quantized model 31a, inferring data 31b, and an inference result 31c.

The obtaining unit 32 obtains the machine-learned quantized model 31a and the inferring data 31b, and stores the obtained model and the obtained data into the memory unit 31. As an example, the obtaining unit 32 may receive the machine-learned quantized model 21d from the server 2 via a non-illustrated network and store the received machine-learned quantized model 21d, as the machine-learned quantized model 31a, into the memory unit 31. As another example, the obtaining unit 32 may generate the inferring data 31b at the terminal 3, or may receive the inferring data 31b from a computer outside the terminal 3 through a non-illustrated network and store the data into the memory unit 31.

In the inferring phase, the inference processing unit 33 executes an inferring process for acquiring the inference result of the machine-learned quantized model 31a based on the inferring data 31b. The inferring process is an example of the inferring process 108 described with reference to FIG. 4.

For example, the inference processing unit 33 may generate (obtain) the inference result 31c by the inferring process, which is executed by inputting the inferring data 31b into the machine-learned quantized model 31a and store the inference result 31c into the memory unit 31.

The inferring data 31b may be, for example, a data set for which a task is to be executed. As an example, when the image recognition or object detection task is to be executed, the inferring data 31b may include multiple pieces of data such as image data.

The inference result 31c may include various information regarding a result of predetermined processing output from the machine-learned quantized model 31a by execution of a task, such as a result of recognizing an image and a result of detecting an object.

The outputting unit 34 outputs the inference result 31c. For example, the outputting unit 34 may display the inference result 31c on a display device of the terminal 3 or may be transmitted to a computer outside the terminal 3 via a non-illustrated network.

[1-2] One Example of an Optimizing Process

Next, description will now be made in relation to an example of an optimizing process performed by the optimization processing unit 24 of the server 2 will now be described. The graph optimizing process by the optimization processing unit 24 may include at least part of the processes (I) to (IV) of the graph optimizing process 105 illustrated in FIG. 4. Hereinafter, a description will now be made focusing on differences from the process of (I) to (IV) described above.

For example, the optimization processing unit 24 obtains the minimum values (Min) and maximum values (Max) of the input and the weight of each channel of the convolution processing unit 221 in the calibrating process of the above (III).

Furthermore, in the above graph converting process (IV), after the convolution processing unit 221 corrects the weight tensor 230 of a FP32 with the S of each channel 223 of the input tensor 222, the optimization processing unit 24 quantizes the corrected weight tensor 230.

(Obtaining Process of Minimum Value (Min) and Maximum Value (Max) of Each Channel)

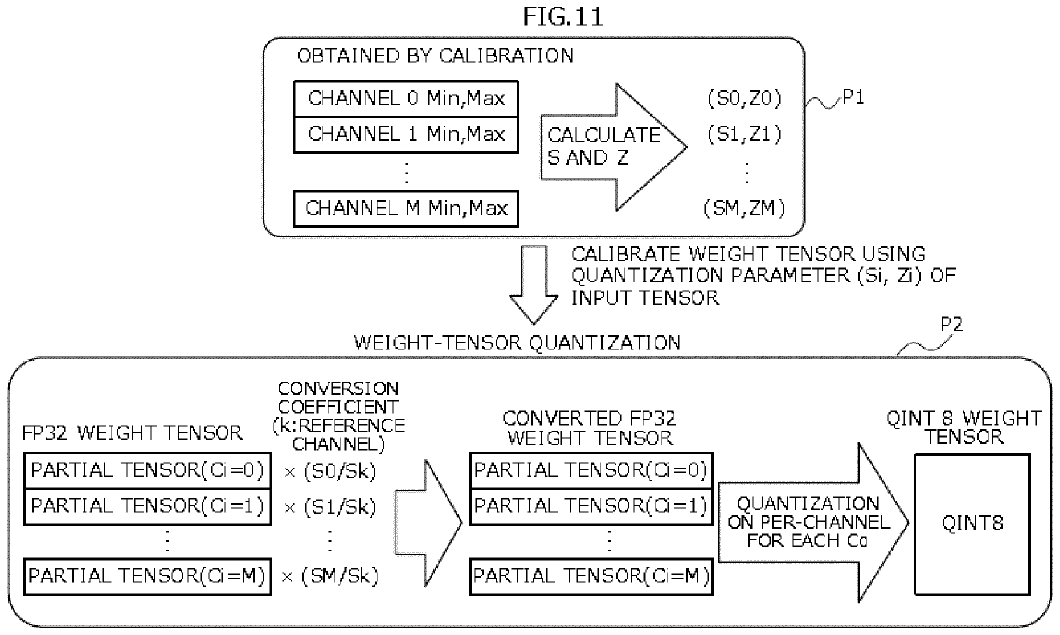

FIG. 11 is a diagram illustrating an example of an obtaining process of a minimum value and a maximum value of each channel by the optimization processing unit 24. As illustrated in FIG. 11, the optimization processing unit 24 executes the per-channel quantization P1 and the weight-tensor quantization P2 on the input tensor 222 in the calibrating process.

For example, in the process P1, the optimization processing unit 24 sets S and Z of each channel 223 of the input tensor 222, which are calculated on the basis of the minimum value and the maximum value for each channel obtained in the calibrating process performed on the machine-learned model 21c, to “S_i” and “Z_i”, respectively. The subscript i of “S” and “Z” is a number for specifying the channel 223, is an integer equal to or greater than “0” and equal to or less than “Ci−1” (=M).

The optimization processing unit 24 may specify the number k of the channel 223 having the maximum “S_i” and may determine the channel 223 having the number k to be the reference for correcting the weight. For example, the optimization processing unit 24 specifies the number k of the channel 223 having the maximum “S_i”, but the manner of determining the number k is not limited to this. Alternatively, the number k may be specified on the basis of the various criteria.

As described above, the optimization processing unit 24 may perform the per-channel quantization on the input tensor 222 and may embed, as constant values, the minimum value (Min) and the maximum value (Max) of each channel 223 in the network.

Further, the optimization processing unit 24, in the process P2, carries out correction (scaling) on each channel of the weight tensor 230, using the quantization parameters “Si and Zi” of the input tensor 222, in other words, the result of scaling each channel 223 of the input tensor 222 of with respect to the input tensor 222.

For example, the optimization processing unit 24 scales each of the multiple channels of the weight tensor 230 on the basis of the ratio of each of the multiple scales to the scale of the reference channel.

As an example, the optimization processing unit 24 may correct, for each convolution processing unit 221, the weight tensor 230 expressed in the FP32 on the basis of “S_i” of each input tensor 222. For example, the optimization processing unit 24 may multiply all elements “W[Co=v: Ci=w: Kh=x: Kw=y]” of the weight tensor 230 with a correction coefficient (S_w/S_k) corresponding to the input channel number w according to the following Expression (8).

W[v][w][x][y]=W[v][w][x][y]*(S_w/S_k) (8)

The optimization processing unit 24 may convert the FP32 value into a QINT8 value by performing the per-channel quantization on each Co using a FP32 value after the correcting calculation based on the above Expression (8) as a new weight value, and embed the converted value, as a constant value, into a network.

Thus, in the optimizing process, the optimization processing unit 24 quantizes the scaled weight tensor 230 for each channel 227 of the output tensor 226 of multiple dimensions of the convolution layer 220.

As described above, the optimization processing unit 24 can reduce the overhead in the convolution of INT8 in the inferring process by embedding the weight tensor 230 into the network after the weight tensor 230 is corrected on the basis of the scale and then converted into the INT8.

[1-3] Example of Inferring Process:

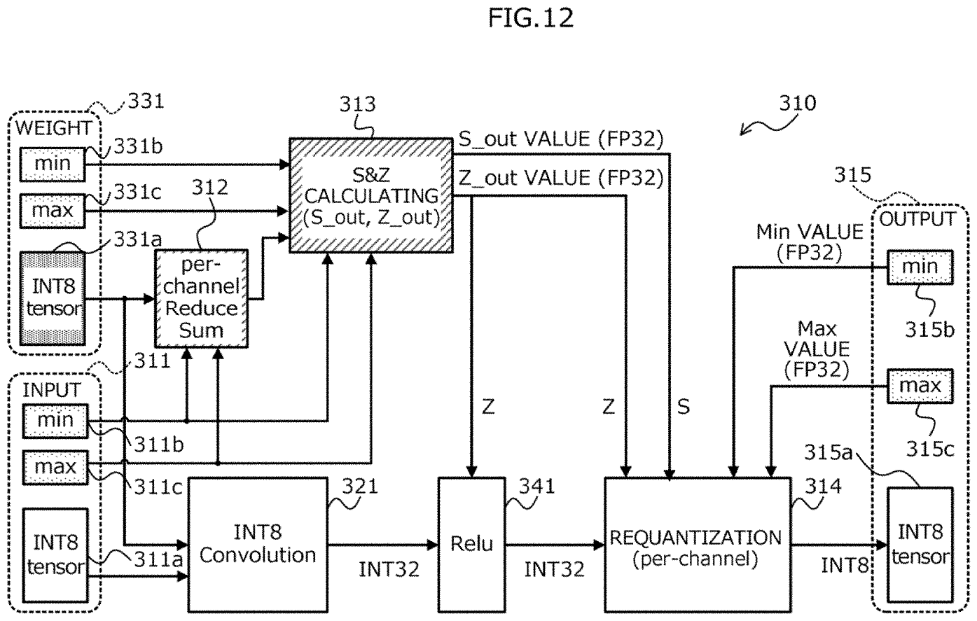

Next, description will now be made in relation to an example of the inferring process performed by the inference processing unit 33 of the terminal 3. FIG. 12 is a diagram illustrating an example of the operation of the inferring process. FIG. 12 illustrates an example of the inferring process in a network 310 of a certain DNN according to the one embodiment. Hereinafter, description will now be made focusing on differences of processes of the inferring process of FIG. 12 from the inferring process illustrated in FIG. 5.

In the example of FIG. 12, QINT quantized data is the input data 311, the weight data 331, and the output data 315. The input data 311 includes an INT8 tensor 311a, a minimum value 311b, and a maximum value 311c; the weight data 331 includes an INT8 tensor 331a, a minimum value 331b, and a maximum value 331c; and the output data 315 includes an INT8 tensor 315a, a minimum value 315b, and a maximum value 315c.

Here, in the weight data 331 illustrated in FIG. 12, the value corrected with the ratio of the S value of the input tensor 222 by the optimization processing unit 24 is set. The INT8 tensor 331a indicated by dark hatching in FIG. 12 is a constant value obtained by quantizing the weight of the results of learning in the machine-learning unit 23. Each of the minimum values 111b, 131b, and 115b, and the maximum values 111c, 131c, and 115c indicated by the thin hatching is a constant value in which the result of the calibrating process is embedded.

The per-channel ReduceSum (hereinafter simply referred to as a “ReduceSum”) 312 adds the elements of all the dimensions of the INT8 tensor 331a for each channel and outputs one tensor (value). At this time, the ReduceSum 312 inputs the minimum value 311b and the maximum value 311c of the input tensor 222 in addition to the INT8 tensor 331a of the weight data 331.

The S&Z calculating 313 calculates the S value (S_out) and the Z value (Z_out) of the output data 315 by performing a scalar operation.

For example, in the ReduceSum 312 and the S&Z calculating 313, the inference processing unit 33 may perform per-channel ReduceSum to convert the output data 315 into a vector of a length Ci, and then may obtain “Z_out” by calculating an inner product with the “Z_in” vector.

Here, the scale of an input channel i of the input tensor 222 is denoted by “S_in[i]” and the Z of the channel i of the input tensor 222 is denoted by “Zin[i]”. Denoting a reference channel and a corrected w by “x” and “w′”, respectively, the following Expression (9) can be obtained and simplifying the Expression (9) with respect to “w” obtains the following Expression (10).

w′[1][m][n]=w[1][m][n]*(S_in[1]/S_in[x]) (9)

w[1][m][n]=w′[1][m][n]*(S_in[x]/S_in[1]) (10)

The inferring processing unit 33 calculates convolution 321 based on the above Expression (10), using the following Expression (11) with respect to the term “out[i] [j] [k]”.

out(FP32)[i][j][k]=Conv(i,j,k)(in(fp32),w(fp32))=Σ1mn(in(fp32)[i+l][j+m][k+n]·w(fp32)[1][m][n])=Σ1mn{(in(int8)[i+l][j+m][k+n]−Z_in[1])·S_in[1]·w(int8)[1][m][n]·S_w} (11)

Here, the term “w” is replaced with the term “w′” on the basis of above Expression (11) using the following Expression (12).

out(FP32)[i][j][k]=Σ1mn{(in(int8)[i+l][j+m][k+n]−Z_in[1])·S_in[1]·w′(int8)[1][m][n]·(S_in[x]/S_in[1])·S_w}=S_in[x]S_w·Σ1mn{(in(int8)[i+l][j+m][k+n]−Z_in[1])·w′(int8)[1][m][n]}=S_in[x]S_w{Conv(i,j,k)(in(int8),w′(int8))−Σ1mnZ_in[1]·w′(int8)[1][m][n]} (12)

From the above Expression (12), the following Expressions (13) and (14) are obtained.

S_out=S_in[x]S_w (13)

Z_out=Σ1mnZ_in[1]·w′(int8)[1][m][n]=Σ1{Z_in[1]-Σmnw′(int8)[1][m][n]} (14)

In the above Expression (13), “S_out” (scale) is the product of the scale “S_in” of the input and the scale S_w of the weight. In the above Expression (14), “Z_out” (zero value) is obtained by summation (calculating the sum) on the product of the Z of the input channel after the summation of the “w” of the input with respect to the width and height directions.

As can be understood from the form of the Expression (14), in ReduceSum 312 illustrated in FIG. 12, the calculation of “Σmnw(int8) [1][m][n]” is performed and thereby a vector of a length Ci is generated, and the inner product calculation is then performed on the vector of Ci and “Z_in” in the S&Z calculating 313.

As described above, the calculation of the ReduceSum 312 and the S&Z calculating 313 indicated by hatching in FIG. 12 is sufficiently smaller in calculation volume than the calculation of the convolution 321 of the INT8, and once the calculation is accomplished, the result can be also be used to other data. Therefore, similarly to the ReduceSum 112 and the S&Z calculating 113 illustrated in FIG. 5, the calculation in the ReduceSum 312 and the S&Z calculation 313 may be performed once in the inferring process.

The convolution 321 performs a convolution process on the basis of the INT8 tensors 311a and 331a, and outputs INT32 values of the accumulation registers.

The inner product operation part in the convolution 321 can be processed by the INT8. This is because the correction on the weight data 331 by the optimization processing unit 24 makes S of the different product terms of the input channel of the inner product calculation consequently the same.

In the example of FIG. 12, the result of calculating in the middle in the convolution 321 is summed to an accumulator of the INT32, and the output from convolution 321 is followed by “int8*int8+int8*int8+ . . . ” because being the result of the inner product calculation. The result of the INT32, in which the product terms are added and which is output from the convolution 321, is subjected to per-channel requantization 314 through the Relu 341, and is output as an INT8 tensor 315a.

As described above, according to the scheme of the one embodiment, it is possible to perform the inferring process by performing per-channel quantization on both the input and the weight processed by the convolution. In addition, when both the input and the weight are per-channel quantized according to the scheme according to the one embodiment, the processing time of the inferring process can be made to be the same as the scheme in which the per-channel quantization is applied to the weight only described with reference to FIG. 8, for example. In other words, it is possible to suppress an increase in the processing time of the inferring process.

This makes it possible to conduct finer quantization than a scheme that applies per-channel quantization on the weight only, so that the inference accuracy can be enhanced.

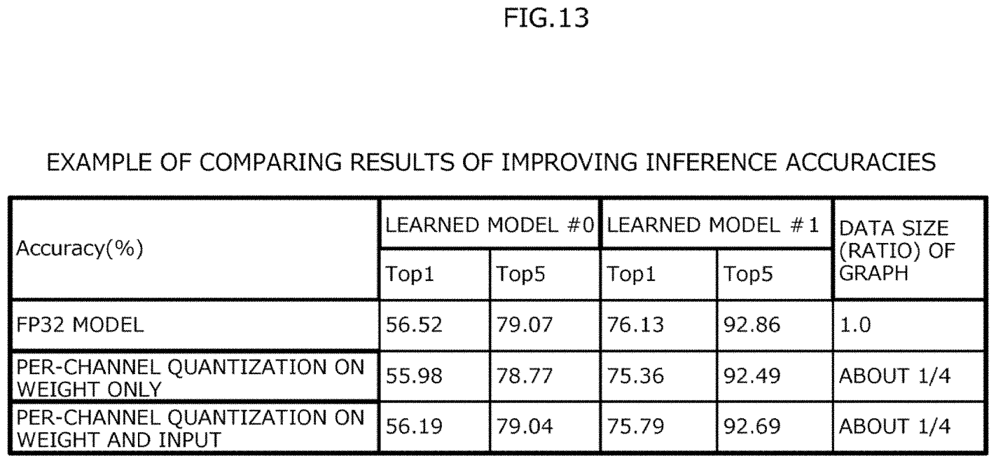

FIG. 13 is a diagram illustrating an example of comparing results of improving inference accuracy when the target of per-channel quantization is “a weight only” and “an input and a weight”.

FIG. 13 illustrates the result of obtaining the recognition accuracy of given data by simulation using a model in which each of the following three changes (a) to (c) is made onto a given learned model #0 and #1. The learned models #0 and #1 include, for example, Alexnet and Resnet50, respectively. The given data includes, for example, validation of Imagenet 2012.

(a) Original FP32 Model.

(b) A model obtained by performing the per-channel quantization on a weight input of the convolution 321 and the tensor-quantization on the data input.

(c) A model obtained by performing the per-channel quantization on both the weight input and the data input of the convolution 321.

As illustrated in FIG. 13, by performing the per-channel quantization on both the weight input and the data input, the recognition accuracy can be enhanced while suppressing an increase of the calculation volume and the data size of the graph in the inferring process as compared with the case where per-channel quantization is performed only on the weight input. The reason why the model (c) can suppress an increase in the data size of the graph as compared with the model (b) is that the minimum value and the maximum value for each layer, which were scalar values in the above model (b), only change to a vector having a length Ci in the above model (c), and the increase amount is small enough to be negligible as compared with the size of the main body of a tensor.

[1-4] Example of Operation:

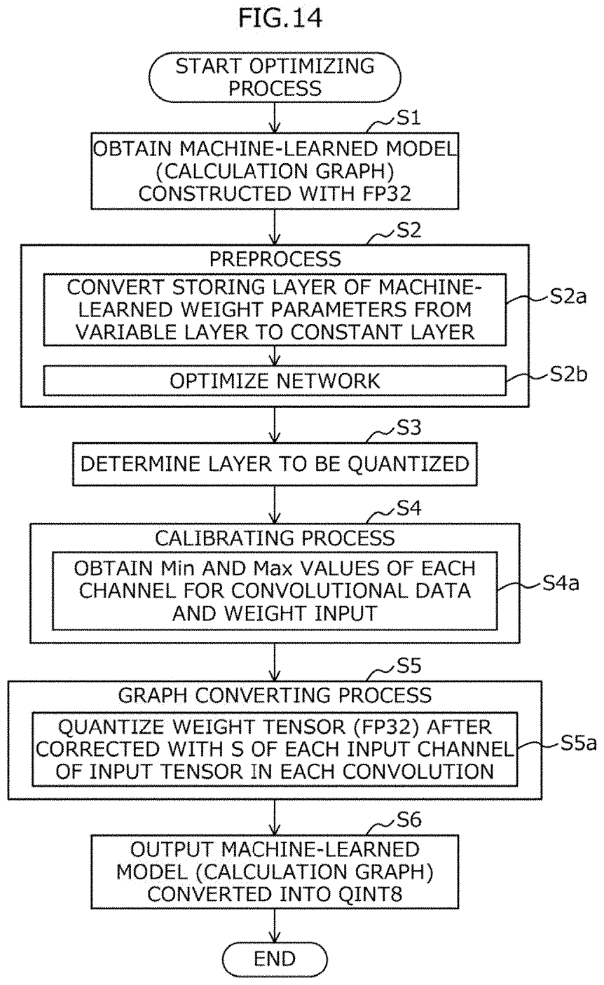

Hereinafter, description will now be made in relation to an example of the operation of the optimizing process in the machine learning process by the server 2 described above with reference to flowcharts. FIG. 14 is a flow diagram illustrating an example of operation of an optimizing process in a machine learning process performed by the server 2 according to the one embodiment.

As illustrated in FIG. 14, the optimization processing unit 24 obtains a machine-learned model 21c (calculation graph) which is constructed by the FP32 and which is also trained by the machine-learning unit 23 (Step S1).

The optimization processing unit 24 performs preprocess on the machine-learned model 21c (Step S2). The preprocess of Step S2 may include, for example, the process (I) (processes (I-1) and (I-2)) described above for the graph optimizing process 105 illustrated in FIG. 4.

For example, in the process (I-1), the optimization processing unit 24 converts the layer storing the machine-learned weight parameters of the machine-learned model 21c from variable layers to constant layers (Step S2a). The optimization processing unit 24 optimizes the network in the process (I-2) (Step S2b).

Then, the optimization processing unit 24 determines a layer to be quantized in the DNN model (Step S3). The determining process of the layer in Step S3 may include the process of (II) described above.

The optimization processing unit 24 performs a calibrating process (Step S4). The calibrating process in Step S4 may include part of the above process of (III).

Here, differently from the above process (III), the optimization processing unit 24 according to the one embodiment obtains the minimum value (min) and the maximum value (max) for each channel of the input and the weight of the convolution 321 in the calibrating process (Step S4a).

The optimization processing unit 24 performs graph converting process (Step S5). The graph converting process in Step S5 may include part of the process of (IV) described above.

Here, differently from the above process (IV), the optimization processing unit 24 of the one embodiment performs the following processing in the graph converting process. For example, the optimization processing unit 24 corrects the weight tensor 230 (weight data 331) of the FP32 in each convolution 321 with S of each channel 223 of the input tensor 222 (input data 311), and performs quantization after the correction (Step S5a).

The optimization processing unit 24 stores the machine-learned quantized model 21d (calculation graph), which is converted into the QINT8 as a result of performing the process of Steps S2 to S5 on the machine-learned model 21c, into the memory unit 21. The outputting unit 25 outputs the machine-learned quantized model 21d (Step S6), and ends the process.

[1-5] Modification:

Next, description will now be made in relation to a modification related to the weight correcting process according to the one embodiment. In the one embodiment, when the optimization processing unit 24 quantizes the weight by multiplying (S_i/S_k), if the dynamic ranges (distribution widths) of the respective channels of the input data are largely different, the differences between the S values of respective channels also increase.

Therefore, when the differences of S among the input channels 223 are large, correcting each weight value by using (S_i/S_k) according to the scheme according to the one embodiment may make the weight value of a channel having a small S very small. Then, when quantization is finally performed for each output channel, the absolute value of the value of the input channel having a small S may come to be a small value such as “0” to “1”. This cancels the effect of enhancing the accuracy achieved by per-channel quantization on the input tensor 222.

In the modification, in order to suppress such a situation, the optimization processing unit 24 corrects the minimum value and the maximum value of the input such that the maximum value of the absolute value of each channel in the input channel direction comes to be a value equal to or larger than a given threshold value K when quantizing the weight after corrected with the S ratio of the input channel. Incidentally, K is a threshold for specifying the maximum value of the absolute value and may be set by the administrator or the user of the server 2 or the terminal 3.

For example, a case is assumed where the maximum value (absmax) of the absolute value of the entire weight data of a certain channel (first channel) P when the weight tensor 230 is quantized is Q (e.g., “Q=2”) under the condition of the threshold K (e.g., “K=4”). In this case, in relation to the channel P, the optimization processing unit 24 re-quantizes the channel P, using the K/Q time (e.g., “2” times) the scale of the input channel P corresponding to an input tensor 222, so that the maximum value is made to K (“K=4”). Further, the optimization processing unit 24 multiplies the S of the input channel P of the input tensor 222 with Q/K (e.g., “½” times).

As described above, the optimization processing unit 24 increases the minimum value and the maximum value of the first input channel 223 corresponding to the first channel P having the maximum value Q of the absolute value of the data within the channel in the quantized weight tensor 230 being less than the threshold K (i.e., Q>K) on the basis of the maximum value Q of the first channel P and the threshold value K. Further, the optimization processing unit 24 quantizes (requantizes), based on the scale based on the increased minimum value and maximum value, the first channel P of the quantized weight tensor 230.

Thereby, since both the input tensor value (INT8) and the weight value (INT8) will be quantized while reserving data width in a certain range or more, the inference accuracy can be improved even when there is a difference in the dynamic ranges of the respective channels 223 of the input tensor 222.

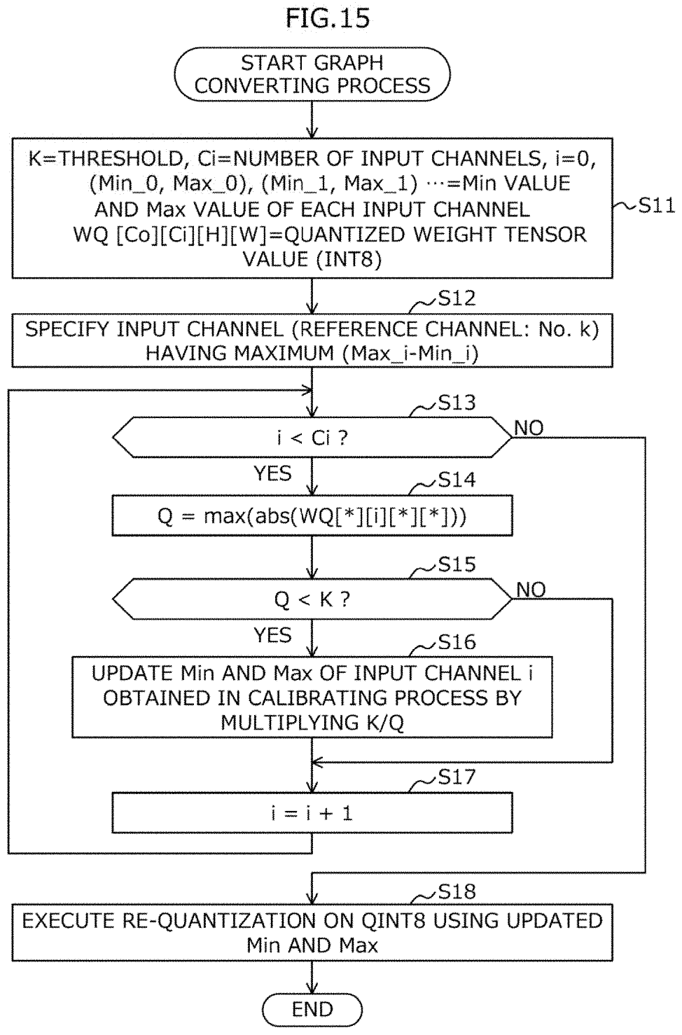

FIG. 15 is a diagram illustrating an example of operation of the modification to the one embodiment. The processing illustrated in FIG. 15 may be performed on all the convolution layers 220 in the graph after the processing of Step S5a is completed in the graph converting process (Step S5) of FIG. 14.

As illustrated in FIG. 15, the optimization processing unit 24 sets various variables and constants (Step S11). For example, the optimization processing unit 24 sets a threshold value to the threshold value K, sets the number of input channels to Ci, and sets “0” to the variable i. In addition, the optimization processing unit 24 sets the minimum value (Min) and the maximum value (Max) of each input channel 223 in “(Min_0,Max_0), (Min_1,Max_1) . . . ” Furthermore, the optimization processing unit 24 sets the weight tensor value (INT8) after the quantization to “WQ[Co][Ci][H][W]”.

The optimization processing unit 24 detects the reference channel. As an example, the optimization processing unit 24 specifies the input channel having the maximum “Max_i−Min_i” as the reference channel (number k) (Step S12), and uses the specified reference channel for a repetitious process performed the same number of times as the number of input channels in steps S13 to S17.

The optimization processing unit 24 determines whether or not the relationship “i<Ci” is satisfied (Step S13), and when “i<Ci” is satisfied (YES in Step S13), calculates “Q=max(abs(WQ[*] [i] [*] [*]]))” (Step S14). The term “max(abs(WQ[*] [i] [*] [*]]))” is a function for calculating the absolute value of the maximum value of the weight tensor value (INT8) after the quantization.

The optimization processing unit 24 determines whether or not the relationship “Q<K” is satisfied (Step S15). In cases where the relationship “Q<K” is satisfied (YES in Step S15), the optimization processing unit 24 updates the minimum value (Min) and the maximum value (Max) of the input channel i obtained in the calibrating process (see step S4 in FIG. 14) by multiplying K/Q (Step S16).

The optimization processing unit 24 increments i (Step S17), and the process proceeds to Step S13. In cases where the relationship “Q<K” is not satisfied (NO in Step S15), the process proceeds to Step S17.

In cases where the relationship “i<Ci” is not satisfied (No in Step S13), the optimization processing unit 24 executes re-quantization on QINT8 of the weight using the updated minimum values (Min) and maximum values (Max) of the same number as input channels (Step S18), and then ends the process.

[1-6] Example of Hardware Configuration:

The server 2 and the terminal 3 of the one embodiment may each be a virtual server (VMs; Virtual Machine) or physical server.

The functions of each of the server 2 and the terminal 3 may be each achieved by one computer or by two or more computers. Further, at least some of the respective functions of the server 2 and the terminal 3 may be implemented using Hardware (HW) and Network (NW) resources provided by a cloud environment.

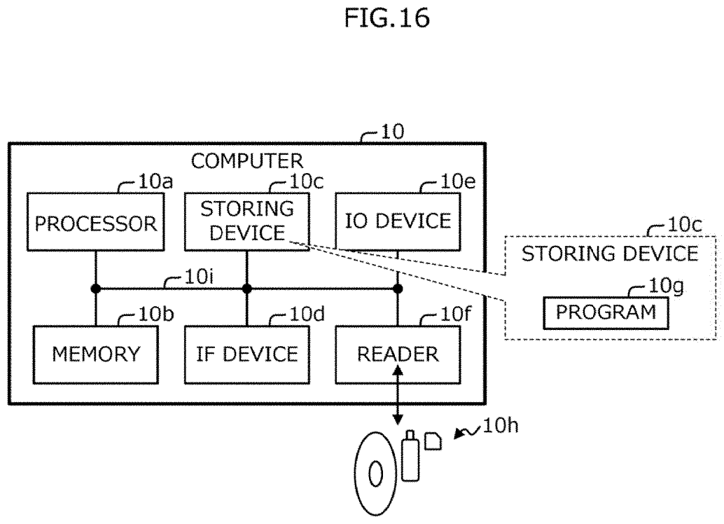

FIG. 16 is a block diagram illustrating an example of a hardware (HW) configuration of the computer 10. In the following description, a hardware device that implements the function of each of the server 2 and the terminal 3 is exemplified by a computer 10. When multiple computers are used as the HW resources for implementing the functions of the server 2 and the terminal 3, each computer may have a HW configuration illustrated in FIG. 16.

As illustrated in FIG. 16, the computer 10 may exemplarily include a processor 10a, a memory 10b, a storing device 10c, an IF (Interface) device 10d, an IO (Input/Output) device 10e, and a reader 10f as the HW configuration.

The processor 10a is an example of an arithmetic processing apparatus that performs various controls and arithmetic operations. The processor 10a may be communicably connected to the blocks in the computer 10 to each other via a bus 10i. The processor 10a may be a multiprocessor including multiple processors, a multi-core processor including multiple processor cores, or a configuration including multiple multi-core processors.

An example of the processor 10a is an Integrated Circuit (IC) such as a Central Processing Unit (CPU), a Micro Processing Unit (MPU), a Graphics Processing Unit (GPU), an Accelerated Processing Unit (APU), a Digital Signal Processor (DSP), an Application Specific IC (ASIC), and a Field-Programmable Gate Array (FPGA). Alternatively, the processor 10a may be a combination of two or more ICs exemplified as the above.

The memory 10b is an example of a HW device that stores information such as various data pieces and programs. An example of the memory 10b includes one or both of a volatile memory such as the Dynamic Random Access Memory (DRAM) and a non-volatile memory such as the Persistent Memory (PM).

The storing device 10c is an example of a HW device that stores information such as various data pieces and programs. Examples of the storing device 10c is various storing devices exemplified by a magnetic disk device such as a Hard Disk Drive (HDD), a semiconductor drive device such as an Solid State Drive (SSD), and a non-volatile memory. Examples of a non-volatile memory are a flash memory, a Storage Class Memory (SCM), and a Read Only Memory (ROM).

The storing device 10c may store a program 10g (machine-learning program) that implements all or part of the functions of the computer 10.

For example, the processor 10a of the server 2 can implement the function of the server 2 (e.g., the obtaining unit 22, the machine-learning unit 23, the optimization processing unit 24, and the outputting unit 25) in FIG. 10 by, for example, expanding the program 10g stored in the storing device 10c onto the memory 10b and executing the expanded program. Likewise, the processor 10a of the terminal 3 can implement the function of the terminal 3 (e.g., the obtaining unit 32, the inference processing unit 33, and the outputting unit 34) in FIG. 10 by, for example, expanding the program 10g stored in the storing device 10c onto the memory 10b and executing the expanded program.

The memory unit 21 illustrated in FIG. 10 may be achieved by a storing region which at least one of the memory 10b or the storing device 10c has. Likewise, the memory unit 31 illustrated in FIG. 10 may be achieved by a storing region which at least one of the memory 10b or the storing device 10c has.

The IF device 10d is an example of a communication IF that controls connection to and communication with a network. For example, the IF device 10d may include an adaptor compatible with a Local Area Network (LAN) such as Ethernet (registered trademark) and an optical communication such as Fibre Channel (FC). The adaptor may be compatible with one of or both of wired and wireless communication schemes. For example, the server 2 may be communicably connected with the terminal 3 or a non-illustrated computer through the IF device 10d. At least part of function of the obtaining units 22 and 32 may be achieved by the IF device 10d. Further, the program 10g may be downloaded from a network to a computer 10 through the communication IF and then stored into the storing device 10c, for example.

The IO device 10e may include one of or both of an input device and an output device. Examples of the input device are a keyboard, a mouse, and a touch screen. Examples of the output device are a monitor, a projector, and a printer. For example, the outputting unit 34 may be output the inference result 31c to the output device of the IO device 10e and causes the IO device 10e to display the inference result 31c.

The reader 10f is an example of a reader that reads information of data and programs recorded on a recording medium 10h. The reader 10f may include a connecting terminal or a device to which the recording medium 10h can be connected or inserted. Examples of the reader 10f include an adapter conforming to, for example, Universal Serial Bus (USB), a drive apparatus that accesses a recording disk, and a card reader that accesses a flash memory such as an SD card. The program 10g may be stored in the recording medium 10h. The reader 10f may read the program 10g from the recording medium 10h and store the read program 10g into the storing device 10c.

An example of the recording medium 10h is a non-transitory computer-readable recording medium such as a magnetic/optical disk, and a flash memory. Examples of the magnetic/optical disk include a flexible disk, a Compact Disc (CD), a Digital Versatile Disc (DVD), a Blu-ray disk, and a Holographic Versatile Disc (HVD). Examples of the flash memory include a semiconductor memory such as a USB memory and an SD card.

The HW configuration of the computer 10 described above is merely illustrative. Accordingly, the computer 10 may appropriately undergo increase or decrease of HW (e.g., addition or deletion of arbitrary blocks), division, integration in an arbitrary combination, and addition or deletion of the bus. For example, at least one of the IC device 10e and the reader 10f may be omitted in the server 2 and the terminal 3.

[2] Miscellaneous:

The techniques according to the one embodiment and the modification described above can be modified and implemented as follows.

For example, the description uses the QINT8 that converts an FP32 into an INT8 as an example of the scheme of the quantization, but the scheme is not limited to the QINT8. Alternatively, various quantizing schemes that reduce the bit-width used for data expression of parameters may be applied.

Further, for example, the obtaining unit 22, the machine-learning unit 23, the optimization processing unit 24, and the outputting unit 25 included in the server 2 illustrated in FIG. 10 may be merged and may be divided respectively. In addition, for example, the obtaining unit 32, the inference processing unit 33, and the outputting unit 34 included in the terminal 3 illustrated in FIG. 10 may be merged or may be divided. Further, the function blocks provided in each of the server 2 and the terminal 3 illustrated in FIG. 10 may be provided in either the server 2 or the terminal 3, or may be implemented as functions across the server 2 and the terminal 3. Alternatively, the server 2 and the terminal 3 may be achieved by as a physically or virtually integrated calculating machine.

Further, for example, one or the both of the server 2 and the terminal 3 illustrated in FIG. 10 may be configured to achieve each processing function by mutually cooperating multiple apparatuses via a network. As an example, in the server 2, the obtaining unit 22 and the outputting unit 25 may be a Web server and an application server, the machine-learning unit 23 and the optimization processing unit 24 may be an application server, and the memory unit 21 may be a DB server. As another example, in the terminal 3, the obtaining unit 32 and the outputting unit 34 may be a Web server and an application server, the inference processing unit 33 may be an application server, the memory unit 31 may be a DB server, or the like. In these case, the processing functions as the server 2 and the terminal 3 may be achieved by the web server, the application server, and the DB server cooperating with one another via a network.

As one aspect, the embodiment described above can enhance the inference accuracy in an inferring process using a neural network including convolution layers.

Throughout the descriptions, the indefinite article “a” or “an” does not exclude a plurality.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A non-transitory computer-readable recording medium having stored therein a machine learning program executable by one or more computers, the machine learning program comprising:
in a quantizing process that reduces a bit width to be used for data expression of a parameter included in a machine-learned model in a neural network including a convolution layer,
scaling, based on a result of scaling input data in the convolution layer for each input channel, weight data in the convolution layer for the channel; and
quantizing the scaled weight data for each output channel of multi-dimensional output data of the convolution layer.

2. The non-transitory computer-readable recording medium according to claim 1, wherein
the weight data comprises a plurality of channels associated one with each of a plurality of the input channel, and
the scaling of the weight data comprising
calculating a scale of the input channel based on a minimum value and a maximum value of each of the plurality of input channels obtained by calibrating the machine-learned model, and
scaling, based on a plurality of the scales, each of the plurality of channels of the weight data for the input channel.

3. The non-transitory computer-readable recording medium according to claim 2, wherein
the scaling of the weight data comprises
specifying a reference channel based on the minimum value and the maximum value for each of the plurality of input channels from among the plurality of input channels, and
scaling, based on a ratio of each of the plurality of scales to a scale of the reference channel, each of the plurality of channels of the weight data.

4. The non-transitory computer-readable recording medium according to claim 2, the machine learning program further comprising:
an instruction for increasing, based on a maximum value of an absolute value of data within of a first channel and a threshold, a minimum value and the maximum value of a first input channel, the maximum value being less than the threshold, and
an instruction for quantizing, based on the increased minimum value and the increased maximum value, the first channel among the quantized weight data.

5. A computer-implemented method for machine learning comprising:
in a quantizing process that reduces a bit width to be used for data expression of a parameter included in a machine-learned model in a neural network including a convolution layer,
scaling, based on a result of scaling input data in the convolution layer for each input channel, weight data in the convolution layer for the channel; and
quantizing the scaled weight data for each output channel of multi-dimensional output data of the convolution layer.

6. The computer-implemented method according to claim 5, wherein
the weight data comprises a plurality of channels associated one with each of a plurality of the input channel, and
the scaling of the weight data comprising
calculating a scale of the input channel based on a minimum value and a maximum value of each of the plurality of input channels obtained by calibrating the machine-learned model, and
scaling, based on a plurality of the scales, each of the plurality of channels of the weight data for the input channel.

7. The computer-implemented method according to claim 6, wherein
the scaling of the weight data comprises
specifying a reference channel based on the minimum value and the maximum value for each of the plurality of input channels from among the plurality of input channels, and
scaling, based on a ratio of each of the plurality of scales to a scale of the reference channel, each of the plurality of channels of the weight data.

8. The computer-implemented method according to claim 6, further comprising:
increasing, based on a maximum value of an absolute value of data within of a first channel and a threshold, a minimum value and the maximum value of a first input channel, the maximum value being less than the threshold; and
quantizing, based on the increased minimum value and the increased maximum value, the first channel among the quantized weight data.

9. A calculating machine comprising:
a memory;
a processor coupled to the memory, the processor being configured to:
in a quantizing process that reduces a bit width to be used for data expression of a parameter included in a machine-learned model in a neural network including a convolution layer,
scale, based on a result of scaling input data in the convolution layer for each input channel, weight data in the convolution layer for the channel, and
quantize the scaled weight data for each output channel of multi-dimensional output data of the convolution layer.

10. The calculating machine according to claim 9, wherein
the weight data comprises a plurality of channels associated one with each of a plurality of the input channel, and
the processor is further configured to,
in the scaling of the weight data,
calculate a scale of the input channel based on a minimum value and a maximum value of each of the plurality of input channels obtained by calibrating the machine-learned model, and
scale, based on a plurality of the scales, each of the plurality of channels of the weight data for the input channel.

11. The calculating machine according to claim 10, wherein
the processor is further configured to,
in the scaling of the weight data,
specify a reference channel based on the minimum value and the maximum value for each of the plurality of input channels from among the plurality of input channels, and
scale, based on a ratio of each of the plurality of scales to a scale of the reference channel, each of the plurality of channels of the weight data.

12. The calculating machine according to claim 10, wherein
the processor is further configured to
increase, based on a maximum value of an absolute value of data within of a first channel and a threshold, a minimum value and the maximum value of a first input channel, the maximum value being less than the threshold, and
quantize, based on the increased minimum value and the increased maximum value, the first channel among the quantized weight data.
